(19) United States
(12) Patent Application Publication
(10) Pub. No.: US 2025/0009030 A1
(43) Pub. Date: Jan. 9, 2025

(54) APPARATUS FOR HEATING AEROSOL GENERATING MATERIAL

(71) Applicant: NICOVENTURES TRADING LIMITED, London (GB)

(72) Inventors: Luke WARREN, London (GB); Matthew HODGSON, London (GB); Anton KORUS, Derby (GB)

(21) Appl. No.: 18/711,662

(22) PCT Filed: Nov. 21, 2022
(86) PCT No.: PCT/EP2022/082534

§ 371 Date: May 20, 2024

(30) Foreign Application Priority Data
Nov. 25, 2021 (GB) 2116980.0

(51) Int. Cl. A24F 40/465; A24F 40/46; A24F 40/51; H05B 6/10

(52) U.S. Cl. CPC A24F 40/465; A24F 40/46; A24F 40/51; H05B 6/105

(57) ABSTRACT

An apparatus for heating aerosol generating material to volatize at least one component of the aerosol generating material, the apparatus includes a heating assembly having a heating cavity arranged to receive at least a portion of an article including aerosol generating material. A heating element protrudes in the heating cavity arranged to be at least partially inserted into the at least the portion of the article including aerosol generating material. The heating element also has a chamber in the heating element which is fluidly isolated from the heating cavity.

### RELATED APPLICATIONS

The present application is a National Phase entry of PCT Application No. PCT/EP2022/082534 filed Nov. 21, 2022, which claims priority to GB Application No. 2116980.0 filed Nov. 25, 2021, each of which is hereby incorporated by reference in their entirety.

### TECHNICAL FIELD

The present invention relates to an apparatus for heating aerosol generating material to volatize at least one component of the aerosol generating material. The present invention also relates to an aerosol generating device for generating an aerosol from aerosol-generating material, a system comprising an apparatus for heating aerosol generating material and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an apparatus for heating aerosol generating material to volatize at least one component of the aerosol generating material, the apparatus comprising: a heating assembly comprising a heating cavity arranged to receive at least a portion of an article comprising aerosol generating material; and a heating element protruding in the heating cavity arranged to be at least partially inserted into the at least the portion of the article comprising aerosol generating material; wherein the heating element comprises a chamber in the heating element; and wherein the chamber is fluidly isolated from the heating cavity.

The apparatus may comprise a sensor configured to determine a characteristic of an inner side of the heating element.

The sensor may be in the chamber.

The sensor may be a temperature sensor. The sensor may be a thermocouple.

The sensor may be on the inner side of the heating element.

The chamber may be a filled chamber.

The apparatus may comprise a filler material in the chamber to seal the sensor in the chamber.

The filler material may be an insulative material.

The heating element chamber may be closed at one end.

The heating element chamber may be closed at a free end of the heating element.

The heating element may be configured to be heated by resistive heating.

The heating element may be configured to be heated by inductive heating.

The heating element may comprise a material heatable by a varying magnetic field.

The apparatus may comprise an inductive coil configured to generate the varying magnetic field.

The inductive coil may encircle at least part of the heating element.

The heating element may comprise a base portion and a heating member upstanding from the base portion.

The heating member may be configured to be heated by the inductive coil.

The base portion may be configured to be heated by the inductive coil.

The heating member may be formed of a non-ferrous material.

The base portion may be formed from a ferrous material.

The heating member may have a greater thermal conductivity than the base portion.

The heating assembly may comprise a receptacle defining the heating cavity.

A fluid seal may be formed between the heating element and the receptacle.

The receptacle may be a tubular member.

The receptacle may comprise a base. A fluid seal may be formed between the heating element and the base. The heating element may form the base.

The heating member may comprise a peripheral wall and an end wall. The peripheral wall and the end wall may together form an outer wall of the heating member. The peripheral wall and end wall may be free from apertures extending therethrough.

The peripheral wall and the end wall may be formed of a material heatable by a varying magnetic field.

The chamber may be a capped bore.

According to an aspect, there is provided an aerosol generating device comprising the apparatus as described in any of the passages above.

According to an aspect, there is provided an aerosol generating device for generating an aerosol from aerosol-generating material comprising: a heating zone arranged to receive at least a portion of an article comprising aerosol generating material; and a hollow heating element protruding in the heating zone; wherein the hollow heating element comprises a closed end in the heating zone and an open end external to the heating zone.

According to an aspect, there is provided an aerosol generating system comprising any of the apparatus described above or any of the aerosol generating devices described above and an article comprising aerosol generating material.

The article may be a consumable.

### BRIEF DESCRIPTION OF THE DRAWINGS

Embodiments will now be described, by way of example only, and with reference to the accompanying drawings in which:

FIG. 1 shows a front perspective view of an aerosol generating system with an aerosol generating device and an article inserted into the device;

FIG. 2 shows schematically the aerosol generating system of FIG. 1;

FIG. 3 shows schematically a heating arrangement of the aerosol generating system of FIG. 1; and

FIG. 4 shows schematically another heating arrangement of the aerosol generating system of FIG. 1.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol generating material may include any botanical material, such as any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating cavity of the device which is sized to receive the article.

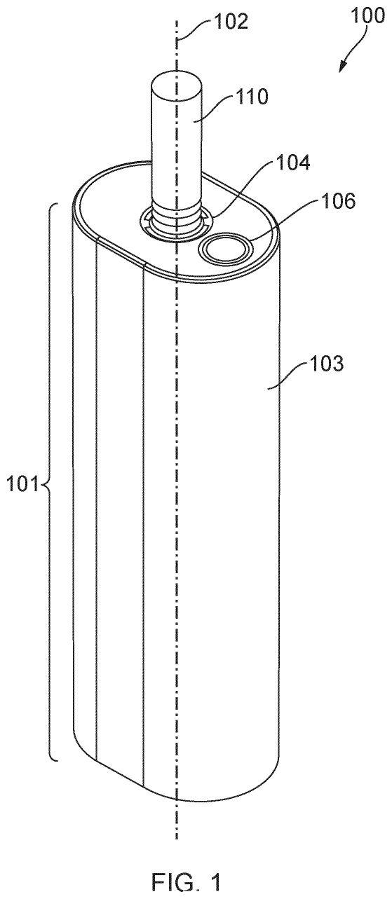

FIG. 1 shows an example of an aerosol generating system 100. The system 100 comprises an aerosol generating device 101 for generating aerosol from an aerosol generating material, and a replaceable article 110 comprising the aerosol-generating material. The device 101 can be used to heat the replaceable article 110 comprising the aerosol-generating material, to generate an aerosol or other inhalable material which can be inhaled by a user of the device 101.

The device 101 comprises a housing 103 which surrounds and houses various components of the device 101. The housing 103 is elongate. The device 101 has an opening 104 in one end, through which the article 110 can be inserted for heating by the device 101. The article 110 may be fully or partially inserted into the device 101 for heating by the device 101.

The device 101 may comprise a user-operable control element 106, such as a button or switch, which operates the device 101 when operated, e.g. pressed. For example, a user may activate the device 101 by pressing the switch 106.

The device 101 defines a longitudinal axis 102, along which an article 110 may extend when inserted into the device 101. The opening 104 is aligned on the longitudinal axis 102.

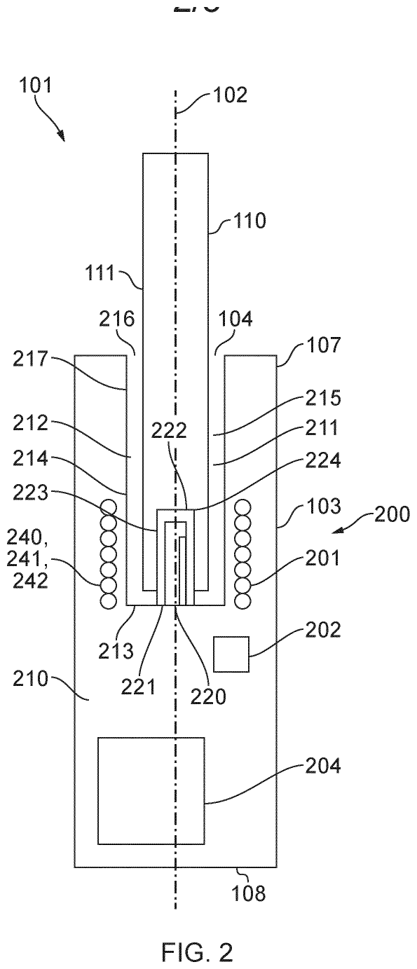

FIG. 2 is a schematic illustration of the aerosol generating system 100 of FIG. 1, showing various components of the device 101. It will be appreciated that the device 101 may include other components not shown in FIG. 2 or may not include some of the components shown in FIG. 2.

As shown in FIG. 2, the device 101 includes an apparatus 200 for heating aerosol-generating material. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol-generating medium or material of an article 110 inserted into the device 101, such that an aerosol is generated from the aerosol-generating material. The power source 204 supplies electrical power to the heating assembly 201, and the heating assembly 201 converts the supplied electrical energy into heat energy for heating the aerosol-generating material.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 101 closest to the opening 104 may be known as the proximal end (or mouth end) 107 of the device 101 because, in use, it is closest to the mouth of the user. In use, a user inserts an article 110 into the opening 104, operates the user control 106 to begin heating the aerosol generating material and draws on the aerosol generated in the device. This causes the aerosol to flow through the article 110 along a flow path towards the proximal end 107 of the device 101.

The other end of the device furthest away from the opening 104 may be known as the distal end 108 of the device 101 because, in use, it is the end furthest away from the mouth of the user. As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field.

The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating cavity 211 configured and dimensioned to receive the article 110 to be heated. The heating cavity 211 defines a heating zone 215. In the present example, the article 110 is generally cylindrical, and the heating cavity 211 is correspondingly generally cylindrical in shape. However, other shapes would be possible. The heating cavity 211 is formed by a receptacle 212. The receptacle 212 includes an end wall 213 and a peripheral wall 214. The end wall 213 acts as a base of the receptacle 212. The receptacle 212 in embodiments is a one-piece component. As used herein, the term ‘one-piece component’ is intended to mean that the features are formed together such that no joints are defined therebetween. In other embodiments the receptacle comprises two or more components.

The heating cavity 211 is defined by the inner surfaces of the receptacle 212. The receptacle 212 acts as a support member. The receptacle 212 comprises a generally tubular member. The receptacle 212 extends along and around and substantially coaxial with the longitudinal axis 102 of the device 101. However, other shapes would be possible. The receptacle 212 (and so heating zone 215) is open at its proximal end such that an article 110 inserted into the opening 104 of the device 101 can be received by the heating cavity 211 therethrough. The receptacle 212 is closed at its distal end by the end wall 213. The receptacle 212 may comprise one or more conduits that form part of an air path. In use, the distal end of the article 110 may be positioned in proximity or engagement with the end of the heating cavity 211. Air may pass through the one or more conduits forming part of the air path, into the heating cavity 211, and flow through the article 110 towards the proximal end of the device 101.

The receptacle 212 is formed free of material that is heatable by penetration with a varying magnetic field. The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. The receptacle 212 may be formed from a rigid material to aid support of other components.

Other arrangements for the receptacle 212 would be possible. For example, in an embodiment the end wall 213 is defined by part of the heating assembly 201. In embodiments, the receptacle 212 comprises material that is heatable by penetration with a varying magnetic field.

As illustrated in FIG. 2, the heating assembly 201 comprises a heating element 220. The heating element 220 is configured to heat the heating zone 215. The heating zone 215 is defined in the heating cavity 211. In embodiments the heating cavity 211 defines a portion of the heating zone 215 or the extent of the heating zone 215.

The heating element 220 extends in the heating zone 215. The heating element 220, acting as a protruding element, protrudes in the heating zone 215. The heating element 220 upstands from the base. The heating element 220 is spaced from the peripheral wall 214. The heating assembly 201 is configured such that when an article 110 is received by the heating cavity 211, the heating element 220 extends into a distal end of the article 110. The heating element 220 is positioned, in use, within the article 110. The heating element 220 is configured to heat aerosol generating material of an article 110 from within, and for this reason is referred to as an inner heating element.

The heating element 220 extends into the heating cavity 211 from the distal end of the heating cavity 211 along the longitudinal axis 102 of the device (in the axial direction). In embodiments the heating element 220 extends into the heating cavity 211 spaced from the axis 102. The heating element 220 may be off-axis or non-parallel to the axis 102. Although one heating element 220 is shown, it will be understood that in embodiments, the heating assembly 201 comprises a plurality of heating elements 220. Such heating elements in embodiments are spaced from but parallel to each other.

The heating element 220 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the cavity 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the cavity 211. An insertion end 112 of the article 110 is arranged to lie adjacent to the base of the receptacle 212.

The heating element 220 extends in the heating zone 215 from the distal end of the receptacle 212. The heating element 220 upstands from the end wall 213. The heating element 220 comprises a heating member 224. The heating member 224 is elongate. The heating element 220 comprises a base end 221 and an opposing free end 222. The heating member 224 is elongate and defines an axis extending along the longitudinal axis 102 of the device 101. The heating member 224 is a pin or column. Other shapes are envisaged, for example the heating member 224 in embodiments is a blade. In embodiments, the heating member 224 upstands from a collar or base portion 225. The base portion 225 may act as a seal to seal with an end of the article 110. The base portion 225 may be omitted.

The heating element 220 comprises an outer surface 223. The outer surface 223 defines a periphery of the heating element 220. The outer surface 223 extends between the base end 221 and the free end 222. The heating element 220 is generally cylindrical although other shapes are envisaged.

The heating element 220 is heatable by inductive or resistive heating. When the heating element is heatable by inductive heating, the heating element 220 is an induction heating element. That is, the heating element 220 comprises a susceptor that is heatable by penetration with a varying magnetic field. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the heating element 220 so as to cause heating in the heating element 220. The magnetic field generator 240 includes an inductor coil arrangement 241. The inductor coil arrangement 241 comprises an inductor coil 242, acting as an inductor element. The inductor coil 242 is a helical coil, however other arrangements are envisaged. In embodiments, the inductor coil arrangement 241 may comprise two or more inductor coils 242. The two or more inductor coils in embodiments may be disposed adjacent to each other and may be aligned co-axially along the axis.

In some examples, in use, the inductor coil is configured to heat the heating element 220 to a temperature of between about 200° C. and about 350° C., such as between about 240° C. and about 300° C., or between about 250° C. and about 280° C.

In any of the herein described embodiments, the magnetic field generator 240 may be configured to generate a varying magnetic field having a frequency of from 800 kHz to 1.5 MHz.

The inductor coil 241 is disposed external to the receptacle 212. The inductor coil 241 encircles the heating zone 215. The helical inductor coil 241 extends around at least a portion of the heating element 220, acting as a susceptor. The helical inductor coil 241 is configured to generate a varying magnetic field that penetrates the heating element 220. The helical inductor coil 241 is arranged coaxially with the heating cavity 211 and longitudinal axis 101.

The inductor coil 241 is a helical coil comprising electrically-conductive material, such as copper. The coil is formed from wire, such as Litz wire, which is wound helically around a support member. The support member is formed by the receptacle 212 or by another component. In embodiments, the support member is omitted. The support member is tubular. The coil 241 defines a generally tubular shape. The inductor coil 241 has a generally circular profile. In other embodiments, the inductor coil 241 may have a different shape, such as generally square, rectangular or elliptical. The coil width may increase or decrease along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximised. By providing an enclosed inductor zone with a helical coil arrangement it is possible to aid the flux concentration of the magnetic field.

Other arrangements for heating the heating element 220 by inductive heating are also envisaged. In one embodiment, the inductor coil 241 is disposed within the heating member 224, rather than being disposed external to the receptacle 212 as described above.

In other embodiments, the susceptor is the base portion 225 of the heating element 220 and heat from the base portion 225 is transferred to the heating member 224 by conduction. In these embodiments, the heating member 224 is formed of a non-ferrous material and the base portion 225 is formed of a ferrous material.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

The heating element 220 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the cavity 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the cavity 211. An insertion end 112 of the article 110 is arranged to lie adjacent to the base of the receptacle 212.

The article 110 comprises a bore 113. The bore 113 is pre-formed in the article 110. The bore 113 is formed in embodiments by a tubular portion of the article 110. The bore 113 in embodiments extends partially along the longitudinal axis of the article. The bore 113 comprises an inner surface 114. The bore 113 has a closed end 115. The heating member 224 is sized to be received in the bore 113. The heating member 224 and bore 113 are complimentary sized to form a slide fit. The inner surface 114 of the bore is configured to form a close contact with the heating member 224 to maximise heat transfer between the heating element 220 and the article 110.

The free end 222 in the present embodiment is blunt. In embodiments, the bore 113 in the article 110 is omitted. In embodiments the outer dimensions of the heating element are greater than those of the bore. In such arrangements, the heating element is configured to deform and/or distend the article 110 to be inserted into the article 110. To facilitate this, the inner heating element 220 is configured to pierce an article 110 that is inserted into the device 101. In such an embodiment, the free end 222 of the heating element 220 comprises a sharp edge or point. The free end 222 of the heating element 220 in embodiments comprises a sharp edge, point or other guide feature to aid location of the heating element 220 in the article 110.

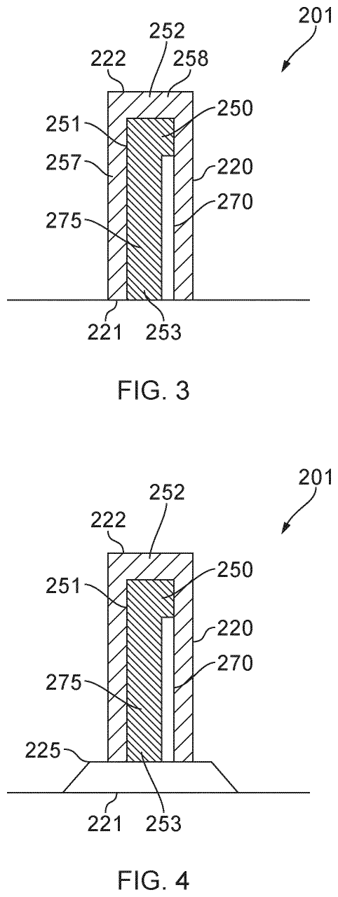

FIG. 3 shows a close-up view of the heating arrangement 201. The heating member 224 comprises a chamber 250. The heating member 224 is hollow or at least partially hollow. The chamber 250 is formed as a bore.

The outer dimensions of the heating member 224 are greater than those of the chamber 250. The chamber 250 comprises an inner surface 251, a closed end 252 and an open end 253. The closed end 252 is located at the free end 222 of the heating element 220. The closed end 252 is towards the proximal end of the heating cavity 211. The open end 253 is located at the base end 221 of the heating element 220. The chamber 250 may take any shape.

A sensor 270 is provided in the chamber 250. The sensor comprises communication wires extending from the sensor 270. The sensor 270 is arranged to determine a characteristic of the inner side of the heating member 224. The sensor 270 is in the chamber 250. The chamber 250 may either completely contain the sensor 270 or partially contain the sensor 270. The sensor 270 in embodiments is mounted to the inner surface 251. In embodiments, the sensor 270 is mounted to the closed end 252 of the chamber 250.

The heating member 224 comprises a peripheral wall 257 and an end wall 258. The peripheral wall 257 and the end wall 258 together form an outer wall of the heating member. The peripheral wall 257 may be tubular. The peripheral wall 257 and the end wall 258 may be free from apertures extending therethrough.

The sensor 270 is in thermal contact with the peripheral wall 257 of the heating member 224. The sensor 270 is on an inner side of the peripheral wall 257 of the heating member 224. The sensor 270 is a temperature sensor. The sensor 270 in embodiments is a thermocouple. By providing the sensor in the heating member 224 it is possible to assist with determining a reliable and accurate temperature reading. The material heatable by a varying magnetic field encircles the sensor 270.

The sensor 270 is fluidly isolated from the heating zone 215. The heating element 220 acts as a fluid barrier to prevent fluid from passing from the heating zone to the chamber 250. As such, the sensor 270 is fluidly isolated. By providing a fluidly isolated chamber it is possible to restrict condensate from coming into contact with the sensor 270.

In embodiments, the chamber 250 is a filled chamber. The chamber 250 comprises a filler material 275 in the chamber to seal the sensor 270 in the chamber 250. The filler material 275 is an electrically insulative material. The insulator 275 in embodiments is a plastic, for example PEEK. The chamber 250 can be fully or partially filled with the filler material 275.

FIG. 4 shows a schematic close-up view of an alternative heating arrangement 201. The configuration of the heating arrangement 201 is generally as described above and so a detailed description will be omitted. In such arrangements, the heating element 220 comprises a base portion 225 and a heating member 224. The heating member 224 is hollow as described above. The open end 253 of the heating member is located at the base portion 225. In the embodiment shown in FIG. 4, the base portion 225 forms the base end 221. In other embodiments, the base portion 225 is positioned on the other side of the base end 221 to the heating member 224. In embodiments, the base portion 225 is formed from a material heatable by a varying magnetic field. Accordingly, the base portion 225 forms the susceptor. The heating member 224 is heated by conduction from the base portion 225. In such an embodiment, the heating member 224 is formed from or free from a material heatable by a varying magnetic field.

In the above described embodiments, the heating arrangement is an inductive heating arrangement. In embodiments, other types of heating arrangement are used, such as resistive heating. The configuration of the device is generally as described above and so a detailed description will be omitted. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An apparatus for heating aerosol generating material to volatize at least one component of the aerosol generating material, the apparatus comprising:
a heating assembly comprising a heating cavity arranged to receive at least a portion of an article comprising aerosol generating material; and
a heating element protruding in the heating cavity arranged to be at least partially inserted into the at least the portion of the article comprising aerosol generating material;
wherein the heating element comprises a chamber in the heating element; and
wherein the chamber is fluidly isolated from the heating cavity.

2. The apparatus of claim 1, comprising a sensor configured to determine a characteristic of an inner side of the heating element.

3. The apparatus of claim 2, wherein the sensor is in the chamber.

4. The apparatus of claim 2, wherein the sensor is a thermocouple.

5. The apparatus of claim 2, wherein the sensor is on the inner side of the heating element.

6. The apparatus of claim 2, wherein the chamber is a filled chamber.

7. The apparatus of claim 2, comprising a filler material in the chamber to seal the sensor in the chamber.

8. The apparatus of claim 7, wherein the filler material is an insulative material.

9. The apparatus of claim 1, wherein the heating element chamber is closed at a free end of the heating element.

10. The apparatus of claim 1, wherein the heating element is configured to be heated by resistive heating.

11. The apparatus of claim 1, wherein the heating element comprises a material heatable by a varying magnetic field.

12. The apparatus of claim 11, comprising an inductive coil configured to generate the varying magnetic field.

13. The apparatus of claim 12, wherein the heating element comprises a base portion and a heating member upstanding from the base portion.

14. The apparatus of claim 13, wherein the heating member is configured to be heated by the inductive coil.

15. The apparatus of claim 13, wherein the base portion is configured to be heated by the inductive coil.

16. The apparatus of claim 15, wherein the heating member is formed of a non-ferrous material.

17. An aerosol generating device comprising the apparatus of claim 1.

18. An aerosol generating device for generating an aerosol from aerosol-generating material comprising:
a heating zone arranged to receive at least a portion of an article comprising aerosol generating material; and
a hollow heating element protruding in the heating zone;
wherein the hollow heating element comprises a closed end in the heating zone and an open end external to the heating zone.

19. An aerosol generating system comprising the apparatus of claim 1 or the aerosol generating device of claim 18, and an article comprising aerosol generating material.

20. The aerosol generating system of claim 19, wherein the article is a consumable.
